(19) United States
(12) Patent Application Publication
(10) Pub. No.: US 2015/0343476 A1
(43) Pub. Date: Dec. 3, 2015

(54) Directional Air Apparatuses, System, and Methods of Using the Same

(71) Applicant: Global Finishing Solutions LLC, Osseo, WI (US)

(72) Inventors: William McFadden, Barrie (CA); Brandon Lowder, Eau Claire, WI (US)

(21) Appl. No.: 14/725,747

(22) Filed: May 29, 2015

Related U.S. Application Data
(60) Provisional application No. 62/004,505, filed on May 29, 2014.

(51) Int. Cl. B05B 15/12; F26B 21/00; F26B 25/10

(52) U.S. Cl. CPC B05B 15/1222; F26B 25/10; F26B 21/003

(57) ABSTRACT

The present invention relates to accelerated directional airflows for use in, preferably, paint booths. Specifically, the present invention relates to apparatuses, systems, and methods of using the same that create an accelerated directional airflow while eliminating the requirement of having multiple vents, nozzles, hoses, and the like. Even more specifically, the present invention controls airflow more efficiently, requires fewer parts, and costs less to use and maintain. Specifically, the accelerated directional airflows are useful in paint booths for drying painted parts and for ventilation.

The present invention claims priority to U.S. Provisional Pat. App. No. 62/004,505 titled, “Directional Air Apparatuses, Systems, and Methods of Using the Same,” filed May 29, 2014, which is incorporated herein by reference in its entirety.

### TECHNICAL FIELD

The present invention relates to accelerated directional airflows for use in, preferably, paint booths. Specifically, the present invention relates to apparatuses, systems, and methods of using the same that create an accelerated directional airflow while eliminating the requirement of having multiple vents, nozzles, hoses, and the like. Even more specifically, the present invention controls airflow more efficiently, requires fewer parts, and costs less to use and maintain. Specifically, the accelerated directional airflows are useful in paint booths for drying painted parts and for ventilation.

### BACKGROUND

It is, of course, generally known to use air regulation apparatuses and systems. Air regulation has generally been used for multiple purposes including, but not limited to, heating, ventilating, air-conditioning (also known as HVAC), filtration, humidifying, de-humidifying, suffocation, drying, curing, directing, and circulating. Commonly, HVAC systems are used to handle everyday needs. Other systems are more situational and implemented on an ad-hoc basis.

Painting is a common situation requiring a specific air regulation system for both drying the paint and ventilation of fumes and chemicals, such as solvents or the like. While paint may dry over time without air regulation, an air regulation system can decrease the time it takes to dry. There are multiple systems that can aide in the drying of paint including circulating air around the painted object, blowing air directly on the painted object, heating the air around the painted object, or any combination thereof. It has been found through comparative tests, that for most paint materials air velocity over the surface being dried has a greater benefit in accelerating drying than does extra heat. This is especially true with the newer waterborne finishes. Downdraft airflow is a generally accepted method for ventilation and drying paint. In downdraft, air flows vertically from a ceiling intake plenum at the top of an area, over an object, and into a filtered exhaust pit in the floor. Downdraft airflow provides a safe, clean environment while controlling overspray and contamination.

Another configuration is a crossdraft system that uses an exhaust fan to pull air in at one end of an area. Air may pass through a filtered door, enter a working area unfiltered, or be pushed in through a pressurized input plenum. Air flows parallel to the floor, across an object and into a filter bank at one end of the area. A semi-downdraft system is a “hybrid”, combining features of both crossdraft and downdraft systems. Air is introduced into an area through the ceiling in the first 25-30% of the area. Then it's pulled across a working area, over an object, and into a filtered exhaust chamber at one end of the area. A side downdraft system is an economical solution for shops that can't afford or aren't able to install floor exhaust chambers. Air enters an area through a full-length ceiling plenum, and flows downward over an object. When air reaches the floor, it is pulled into floor-level filtered exhaust plenums on each side of the area.

Often, paint jobs are not entirely smooth and leave small imperfections, sometimes invisible to the naked eye. While these imperfections may not be noticeable, air and water vapor still may be retained within the small imperfections. Additionally, laminar airflows do not effectively move air and water vapor away from the entire surface of an object and a layer of air and water vapor may form around the boundary of the object. This boundary air remains stationary even when airflow is directed past the boundary air, such as with a downdraft airflow, crossdraft airflow, hybrid downdraft airflow, or any combination thereof. Not only does this boundary air impede the effects of an airflow, but the water vapor hinders the speed of evaporation and drying.

In paint shops, such as automobile repaint shops, production is limited by the time required for the paint to dry. Spray booths or other areas are frequently used both to confine paint overspray and evaporated solvents, and to reduce drying time. As used herein, the term “paint spray booth” is intended to cover both spray booths in which objects are painted and dried and booths in which a painted object is dried or cured.

In the past, paint spray booths and other areas often used an array of infrared lamps for applying heat to painted automobile or other painted object for accelerating drying. The object may be heated, for example, to about 130° F. or 55° C. during drying. In a downdraft paint spray booth or other area, the object is positioned over an open floor grate. Air and any entrained paint overspray and solvents are drawn downwardly over and around the object during spraying and drying and exhausted through the floor grate. An object within a downdraft spray booth, such as a standard sized vehicle, is typically subjected to an air flow on the order of 80 to 100 feet per minute (24.4 to 30.5 meters per minute). In a cross draft system wherein the air flows in a horizontal direction through an area, typical surface air flow velocities are about 75 to 100 feet per minute (22.9 to 30.5 meters per minute). When the object surfaces are heated to about 130° F. or 55° C. at these flow velocities, it may take up to 60 minutes for the entire object to dry sufficiently to permit removal from the area. Until the object is dry, it must be kept in the area to prevent damage to the soft paint. It should be appreciated that the total drying time is limited by the slowest drying surface areas which may not be subjected to significant air flow.

In order to increase the number of objects that can be painted in a given time, attempts have been made to decrease the drying time that each object must spend in a spray booth or other area. Most commonly, infrared heat from permanently installed or portable heat lamps is used. Since the heaters require careful positioning to be effective, permanently installed lamps may not be as effective as portable lamps. Heaters must have electrical interlocks if used inside an area or they must be rolled out of the area during spraying to reduce the risk if igniting any flammable solvents. Attempts also have been made to increase the surface air flow over objects. Nozzles have been mounted on rigidly plumbed headers along a spray booth's or other area's ceiling. Compressed air may be delivered from an external source to the nozzles for increasing the air flow over painted surfaces. However, problems have been encountered with these systems. The fixed nozzles do not offer flexibility with different vehicles. Further, there is an increased risk of contaminating the wet paint with dust, oil, or other contaminants that may be present in the compressed air. Typically, the compressed air was obtained from a conventional shop compressor and compressed air distribution systems. However, the air nozzles required a very high air flow rate in order to be effective, thereby increasing the operating costs and consuming compressed air needed for operating spray guns and other shop tools.

Having air and water vapor retained within the small imperfections around the boundary of a painted object severely restricts the drying process. Commonly, introducing a turbulent airflow eliminates this boundary air and water vapor. Accelerated directional air sources may be introduced at angles different from the downdraft airflow, such that the accelerated directional air intersects with the downdraft airflow. To create accelerated directional airflows, nozzles, jets, or other valves are generally used as focusing tools.

Previous attempts to provide accelerated drying have included fitting the sides of a spray booth with a number of directable high volume air nozzles. The nozzles are individually aimed to provide a desired high air flow rate over the sides and top of the automobile. Further, the nozzles may be aimed specifically at locations which are slow to dry from heat alone. A high volume blower, such as a squirrel cage blower, draws air from near the top of the booth and delivers the air through a manifold to the nozzles. Preferably, a blower and a number of nozzles are formed into a module or air handling device which can be retrofitted into an existing spray booth, as well as installed in new spray booths. A number of the modules are spaced around the booth for selectively directing air flow at all surface areas of a large object. The high volume air flow through the nozzles significantly accelerates the drying time for a painted automobile or other object. The blowers and the nozzles in the different modules may be independently controlled, allowing the operator to direct air at only an area which was painted for zone drying or to increase the air flow only at areas which dry slower than other areas. In these designs, each individual nozzle is formed to swivel over a wide directional range, such as at least a 60° global rotation to facilitate directing the air flow at the surface regions requiring additional drying. Consequently, a large number of nozzles may be easily and quickly set for successively drying different automobile models

Nozzles increase the pressure of air by limiting the volume through the narrow end. This is a direct result of the ideal gas law equation pV=nRT. Air is forced through the narrow end of a nozzle at a much higher speed than that of the air when it entered the nozzle, because forcing a decrease in volume increases the pressure. When air is sprayed through the narrow end of a nozzle, it is generally expelled in a conical fashion. Depending on the type of nozzle, air may be sprayed in a solid stream, in a flat V-shaped fan, a solid cone, a hollow cone, or multiple plume spray. These nozzle sprays intersect larger radiuses the farther the spray is from the nozzle, but smaller radiuses the closer the spray is from the nozzle. Some systems provide multiple sets of nozzles to overlap sprays and accelerate wider volumes of air. However, the spaces surrounding the nozzles are often unaffected by the spray of the nozzles. This may leave gaps in the coverage of the spray from one or multiple nozzles. Therefore, a need exists for apparatuses, systems, and methods that eliminate gaps in fluid spray.

Often, upgrading or retrofitting air regulation apparatuses, systems, and methods involves cutting holes into walls, adding additional duct work, replacing or installing motors, and the like. A need, therefore, exists for standalone apparatuses, systems, and methods that can be installed without modification of the assembly the apparatus, system, and method is installed within.

Furthermore, a need exists for apparatuses, systems, and methods that accelerate air efficiently.

Moreover, a need exists for apparatuses, systems, and methods that dry painted objects more quickly and efficiently.

Additionally, a need exists for apparatuses, systems, and methods that create turbulent air when combined with downdraft airflow.

Also, a need exists for apparatuses, systems, and methods that eliminate boundary air around a painted object.

Further, a need exists for apparatuses, systems, and methods that accelerate low, room, and high temperature air.

### SUMMARY OF THE INVENTION

The present invention relates to accelerated directional airflows for use in, preferably, paint booths. Specifically, the present invention relates to apparatuses, systems, and methods of using the same that create an accelerated directional airflow while eliminating the requirement of having multiple vents, nozzles, hoses, and the like. Even more specifically, the present invention controls airflow more efficiently, requires fewer parts, and costs less to use and maintain. Specifically, the accelerated directional airflows are useful in paint booths for drying painted parts and for ventilation.

To this end, in an embodiment of the present invention, an airflow apparatus is provided. The airflow apparatus comprises an intake housing comprising an air intake; a motor within the intake housing for directing airflow through the intake; a hollow extension having a first surface, a length and a volume therein protruding from the intake housing; and a first slit in the first surface, wherein the motor directs the airflow through the intake, into the hollow extension and out the first slit.

In an embodiment, the airflow apparatus further comprises a directional airflow element disposed over the first slit, wherein the directional airflow element comprises a first flange extending from the surface on a first side of the first slit and a second flange extending from the surface on a second side of the first slit.

In an embodiment, the airflow apparatus further comprises a second slit in the first surface, wherein the motor directs the airflow through the intake, into the hollow extension, and out the second slit.

In an embodiment, the first and second slits are adjacently disposed on the first surface.

In an embodiment, the second slit comprises a directional airflow element disposed over the second slit, wherein the directional airflow element comprises a first flange extending form the surface on a first side of the second slit and a second flange extending from the surface on a second side of the first slit.

In an embodiment, the airflow apparatus further comprises a first air diffuser disposed within the hollow extension, wherein the first air diffuser comprises at least one hole for the airflow to pass therethrough, said first air diffuser disposed between the intake housing and the first slit.

In an embodiment, the airflow apparatus further comprises a first air diffuser disposed within the hollow extension, wherein the first air diffuser comprises at least one hole for the airflow to pass therethrough, said first air diffuser disposed between the intake housing and the first slit; and a second air diffuser disposed within the hollow extension, wherein the second air diffuser comprises at least one hole for the airflow to pass therethrough, said second air diffuser disposed between the first slit and the second slit.

In an embodiment, the airflow apparatus further comprises an end cap on a terminal end of the hollow extension.

In an embodiment, the airflow apparatus further comprises a filter associated with the air intake for filtering air forming the airflow.

In an alternate embodiment of the present invention, a paint spray booth is provided. The paint spray booth comprises an enclosed space surrounded by walls, a ceiling, and a floor, wherein mounted on one wall is an airflow apparatus, said airflow apparatus comprising an intake housing comprising an air intake, a motor within the intake housing for directing airflow through the intake, a hollow extension having a first surface, a length and a volume therein protruding from the intake housing, and a first slit in the first surface, wherein the motor directs the airflow through the intake, into the hollow extension and out the first slit.

In an embodiment, the paint spray booth further comprises a directional airflow element disposed over the first slit of the airflow apparatus, wherein the directional airflow element comprises a first flange extending from the surface on a first side of the first slit and a second flange extending from the surface on a second side of the first slit.

In an embodiment, the paint spray booth further comprises a second slit in the first surface of the airflow apparatus, wherein the motor directs the airflow through the intake, into the hollow extension, and out the second slit.

In an embodiment, the first and second slits of the airflow apparatus are adjacently disposed on the first surface.

In an embodiment, the second slit of the airflow apparatus comprises a directional airflow element disposed over the second slit, wherein the directional airflow element comprises a first flange extending form the surface on a first side of the second slit and a second flange extending from the surface on a second side of the first slit.

In an embodiment, the paint spray booth further comprises a first air diffuser disposed within the hollow extension of the airflow apparatus, wherein the first air diffuser comprises at least one hole for the airflow to pass therethrough, said first air diffuser disposed between the intake housing and the first slit.

In an embodiment, the paint spray booth further comprising: a first air diffuser disposed within the hollow extension of the airflow apparatus, wherein the first air diffuser comprises at least one hole for the airflow to pass therethrough, said first air diffuser disposed between the intake housing and the first slit; and a second air diffuser disposed within the hollow extension of the airflow apparatus, wherein the second air diffuser comprises at least one hole for the airflow to pass therethrough, said second air diffuser disposed between the first slit and the second slit.

In an embodiment, the first surface is angled downwardly toward the floor to direct the airflow toward the floor.

In an embodiment, the paint spray booth further comprises a filter associated with the air intake for filtering air forming the airflow.

In an embodiment, the paint spray booth further comprises a ventilation system for removing air from the enclosed space.

In an embodiment, the paint spray booth further comprises an object disposed within the enclosed area, the airflow apparatus directing the airflow around the object for curing paint disposed on the object.

It is, therefore, an advantage and objective of the present invention to provide for apparatuses, systems, and methods that that accelerate air efficiently

It is an advantage and objective of the present invention to provide for standalone apparatuses, systems, and methods that can be installed without modification of the assembly the apparatus, system, and method is installed within.

Furthermore, it is an advantage and objective of the present invention to provide for apparatuses, systems, and methods that eliminate gaps in fluid spray.

Additionally, it is an advantage and objective of the present invention to provide for apparatuses, systems, and methods that create turbulent air when combined with downdraft airflow.

Also, it is an advantage and objective of the present invention to provide for apparatuses, systems, and methods that eliminate boundary air around a painted object.

Further, it is an advantage and objective of the present invention to provide for apparatuses, systems, and methods that accelerate low, room, and high temperature air.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a partial view of an area with an accelerator installed in an embodiment of the present invention.

FIG. 2 illustrates a side view of a right oriented accelerator in an embodiment of the present invention.

FIG. 3 illustrates a perspective view of the right oriented accelerator in an embodiment of the present invention.

FIG. 4 illustrates a perspective exploded view of an extension of the right oriented accelerator in an embodiment of the present invention.

FIG. 5 illustrates a perspective view of a left oriented accelerator in an embodiment of the present invention.

FIG. 6 illustrates a perspective exploded view of an extension of the left oriented accelerator in an embodiment of the present invention.

### DETAILED DESCRIPTION OF THE PRESENTLY PREFERRED EMBODIMENTS

The present invention relates to accelerated directional airflows for use in, preferably, paint booths. Specifically, the present invention relates to apparatuses, systems, and methods of using the same that create an accelerated directional airflow while eliminating the requirement of having multiple vents, nozzles, hoses, and the like. Even more specifically, the present invention controls airflow more efficiently, requires fewer parts, and costs less to use and maintain. Specifically, the accelerated directional airflows are useful in paint booths for drying painted parts and for ventilation.

The terms fluid and flow as described herein are used to refer to a substance whose molecules flow freely, so that it has no fixed shape and little resistance to outside stress, which may be a liquid or a gas. It is not intended to limit disclosure to either a liquid or gas as these substances are both capable of being described with fluid dynamics. Further, while the present invention may have air regulation as one of the embodiments, use of liquids such as water may be used similarly without departing from the spirit and scope of the present invention and without diminishing its attendant advantages

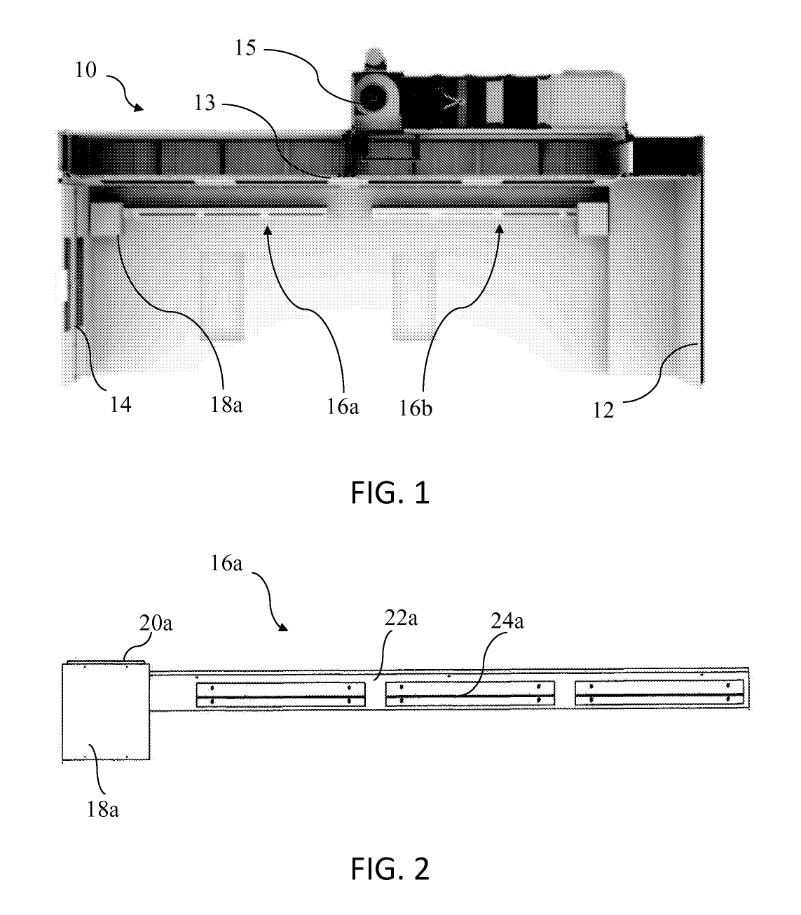

Now referring to the figures, wherein like numerals refer to like parts, FIG. 1 illustrates an area 10, which may be a paint booth in one embodiment of the present invention. The area 10 may comprise a plurality of walls 12, a ceiling 13, and at least one door 14. Within the area 10 may be at least one fluid accelerator 16a or 16b. There may be sufficient space between the at least one fluid accelerator 16a or 16b and the ceiling 13 so that fluid may be able to flow around, beneath, and above the at least one fluid accelerator 16a or 16b. The area 10 may further comprise a ventilation system 15 disposed above the ceiling 13, wherein fluid may be expelled therefrom, sucked into, or recirculated therethrough. The ventilation system 15 may work independently of the at least one accelerator 16a or 16b, may be used concurrently, or may be dependent on the at least one accelerator 16a or 16b. Of course, the at least one accelerator 16a or 16b may also be dependent on the ventilation system 15 in one embodiment of the present invention. In a preferred embodiment of the present invention, fluid may flow from the ventilation system 15 and enter into the at least one accelerator 16a or 16b.

The at least one fluid accelerator 16a or 16b may be a right oriented accelerator 16a or a left oriented accelerator 16b. On a first end of the right oriented accelerator 16a may an intake housing 18a. The intake housing 18a may comprise an intake 20a disposed on a side of the intake housing 18a as shown in FIG. 2. Inside the intake housing 18a may be a motor (not shown) that may suck fluid through the intake 20a, through a filter (not shown), and expel it into an extension 22a. The extension 22a may protrude outwardly from the intake housing 18a and may be connected and sealed such that fluid may flow between the intake housing 18a and the extension 22a but may not flow out the connection between the intake housing 18a and the extension 22a. The extension 22a may have at least one opening 24a having a surface area smaller than the surface area of the extension 22a, wherein fluid may flow from the extension 22a through the at least one opening 24a.

The at least one opening 24a may be sufficiently small such that the fluid flow out the at least one opening 24a decreases its volume and increases its pressure. The increase in pressure can be translated into an increase in velocity. The increase in velocity over time can be translated into acceleration, such that the flow may be accelerated out from the extension 22a and through the at least one opening 24a.

In one embodiment, the at least one opening 24a may be a horizontal slot as shown in FIG. 2. In this embodiment, the height of the at least one opening 24a may be sufficiently small while the width of the at least one opening 24a may be elongated. The sufficiently small height of the at least one opening 24a may still allow fluid flow to be accelerated outwardly from the right oriented accelerator 16a. The elongated width of the at least one opening 24a may provide for a broad level spray of fluid to be accelerated outwardly from the right oriented accelerator 16a.

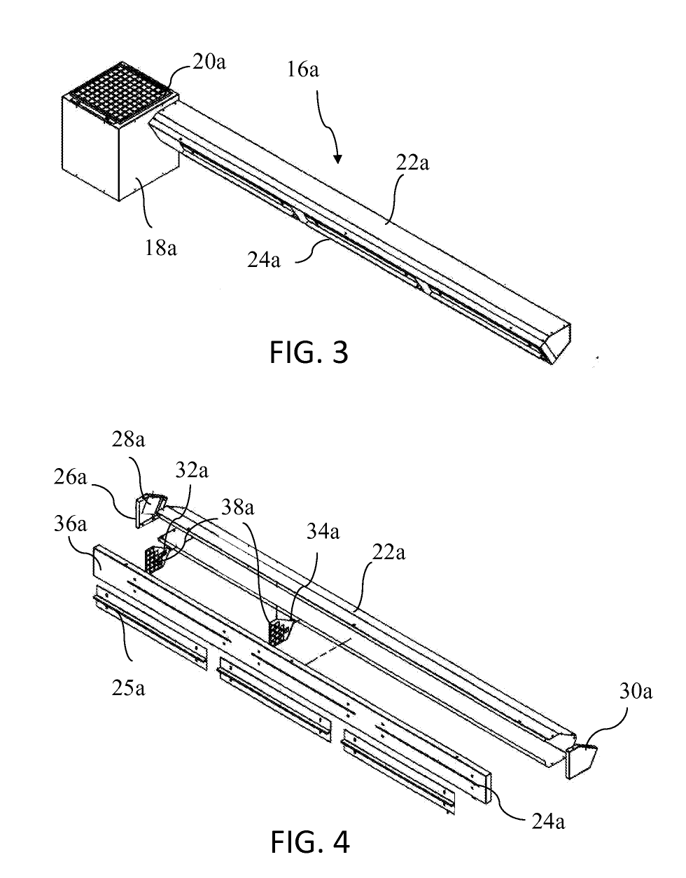

As shown in FIG. 3, the extension 22a may be designed to angle the at least one opening 24a at an angle. This angle may be pre-determined and the right oriented accelerator 16a may be manufactured in accordance with the pre-determined angle. Alternatively, the angle may be determined during installation. In another embodiment of the present invention, the extension 22a may be rotatable about the connection between the intake housing 18a and the extension 22a, such that a user may be able to determine the angle of fluid acceleration at a time of use.

As shown in FIGS. 3-4, the at least one opening 24a may have a plurality of flanges 25a extending away from the extension 22a. The plurality of flanges 25a may focus the fluid flow from the at least one opening 24a and may prevent an unwanted spread of the fluid flow in the vertical direction. Further shown in FIG. 4 is an exploded view of the extension 22a. The extension 22a may be manufactured metal, plastic, or other like material and may be bent in multiple locations. The extension 22a initially may be open on three sides and subsequently enclosed by attaching a connector 26a, an opening wall 36a, and a cap 30a. Specifically, the connector 26a may have an entry 28a wherein fluid may flow therethrough. The connector 26a may be attached to the intake housing 18a (shown in FIG. 3) on a first side of the connector 26a and attached to a first side of the extension 22a on a second side of the connector 26a.

The extension 22a may generally be hollow and may end with the cap 30a on a second side of the extension 22a. The cap 30a may enclose the extension 22a and may prevent fluid flow from exiting the second side of the extension 22a. There may be a first diffuser 32a and a second diffuser 34a disposed throughout the extension 22a. Of course, any number of diffusers may be present. The first and second diffusers 32a, 34a may control fluid flow speed and direction, evenly distribute the flow of fluid, minimize noise, and any combination thereof. In one embodiment, the first diffuser 32a may be disposed on a first side of the at least one opening 24a and the second diffuser 34a may be disposed on a second side of the at least one opening 24a, as seen in FIG. 4.

The first and second diffusers 32a, 34a may have a plurality of apertures 38a to accommodate particular functions. For example, the first diffuser 32a may have 18 apertures while the second diffuser 34a has 12 apertures. The second diffuser 34a may have less apertures 38a than the first diffuser 32a so that the pressure within the extension 22a remains constant, while taking into account any fluid flow out of the at least one opening 24a. The at least one opening 24a may be disposed on the opening wall 36a, which may be attached to the front of the extension 22a. With the connector 26a, the opening wall 36a, and the cap 30a attached to the extension 22a, the extension 22a may be enclosed, except for the entry 28a, the plurality of apertures 38a, and the at least one opening 24a mentioned above. The plurality of flanges 25a may be attached directly on the opening wall 36a and around the at least one opening 24a.

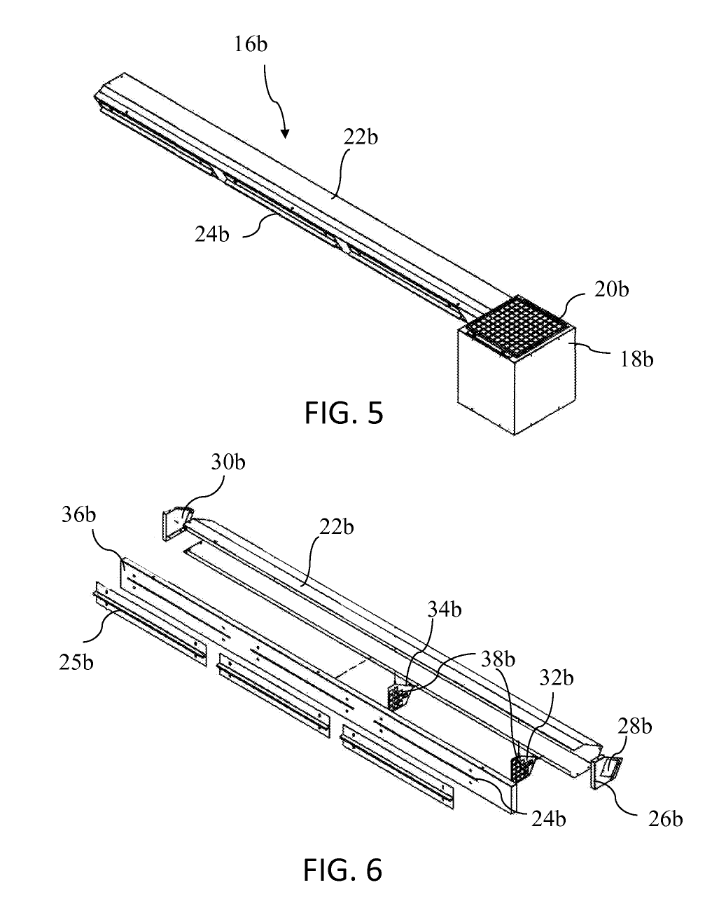

FIG. 5 illustrates a left oriented accelerator 16b, which functions similarly to the right oriented accelerator 16a discussed above. On a first end of the left oriented accelerator 16b may an intake housing 18b. The intake housing 18b may comprise an intake 20b disposed on a side of the intake housing 18b as shown in FIG. 2. Inside the intake housing 18b may be a motor (not shown) that may suck fluid through the intake 20b, through a filter (not shown), and expel it into an extension 22b. The extension 22b may protrude outwardly from the intake housing 18b and may be connected and sealed such that fluid may flow between the intake housing 18b and the extension 22b but may not flow out the connection between the intake housing 18b and the extension 22b. The extension 22b may have at least one opening 24b having a surface area smaller than the surface area of the extension 22b, wherein fluid may flow from the extension 22b through the at least one opening 24b. The at least one opening 24b may be sufficiently small such that the fluid flow out the at least one opening 24b decreases its volume and increases its pressure. The increase in pressure can be translated into an increase in velocity. The increase in velocity over time can be translated into acceleration, such that the flow may be accelerated out from the extension 22b and through the at least one opening 24b. In one embodiment, the at least one opening 24b may be a horizontal slot as shown in FIG. 6. In this embodiment, the height of the at least one opening 24b may be sufficiently small while the width of the at least one opening 24b may be elongated. The sufficiently small height of the at least one opening 24b may still allow fluid flow to be accelerated outwardly from the left oriented accelerator 16b. The elongated width of the at least one opening 24b may provide for a broad level spray of fluid to be accelerated outwardly from the left oriented accelerator 16b.

As further shown in FIG. 5, the extension 22b may be designed to direct the at least one opening 24b at an angle. This angle may be pre-determined and the left oriented accelerator 16b may be manufactured in accordance with the pre-determined angle. Alternatively, the angle may be determined during installation. In another embodiment of the present invention, the extension 22b may be rotatable about the connection between the intake housing 18b and the extension 22b, such that a user may be able to determine the angle of fluid acceleration at a time of use.

As shown in FIGS. 5-6, the at least one opening 24b may have a plurality of flanges 25b extending away from the extension 22b. The plurality of flanges 25b may focus the fluid flow from the at least one opening 24b and may prevent an unwanted spread of the fluid flow in the vertical direction. Further shown in FIG. 6 is an exploded view of the extension 22b. The extension 22b may be manufactured metal, plastic, or other like material and may be bent in multiple locations. The extension 22b may initially be open on three sides and subsequently enclosed by attaching a connector 26b, an opening wall 36b, and a cap 30b thereon. Specifically, the connector 26b may have an entry 28b wherein fluid may flow therethrough. The connector 26b may be attached to the intake housing 18b on a first side of the connector 26b and attached to a first side of the extension 22b on a second side of the connector 26b. The extension 22b may generally be hollow and may end with the cap 30b on a second side of the extension 22b. The cap 30b may enclose the extension 22b and may prevent fluid flow from exiting the second side of the extension 22b.

There may be a first diffuser 32b and a second diffuser 34b disposed throughout the extension 22b. Of course, any number of diffusers may or may not be present. The first and second diffusers 32b, 34b may control fluid flow speed, direction, and distribution; minimize noise; and any combination thereof. In one embodiment, the first diffuser 32b may be disposed on a first side of the at least one opening 24b and the second diffuser 34b may be disposed on a second side of the at least one opening 24b, as seen in FIG. 6.

The first and second diffusers 32b, 34b may have a plurality of apertures 38b to accommodate particular functions. For example, the first diffuser 32b may have 18 apertures while the second diffuser 34b has 12 apertures. The second diffuser 34b may have less apertures 38b than the first diffuser 32b so that the pressure within the extension 22b remains constant, while taking into account any fluid flow out of the at least one opening 24b. The at least one opening 24b may be disposed on the opening wall 36b, which may be attached to the front of the extension 22b. With the connector 26b, the opening wall 36b, and the cap 30b attached to the extension 22b, the extension 22b may be enclosed, except for the entry 28b, the plurality of apertures 38b, and the at least one opening 24b mentioned above. The plurality of flanges 25b may be attached directly on the opening wall 36b and around the at least one opening 24b.

It should be apparent to one skilled in the art that the present invention described above may take in fluid, such as air, water, water vapor, or the like through the intake by engaging the motor within the intake. The fluid may be sucked in from around the present invention and sent into the extension via the gate between the extension and the intake housing. The fluid may fill the extension up to the cap and may further be forced through the at least one openings 24a, 24b at an accelerated rate and in a flat level spray. The flat level spray of fluid accelerated from the present invention may be used concurrently with a ventilation system that provides a downdraft fluid flow, such that the interference of the multiple fluid flow creates turbulent air that can eliminate any air, water vapor, or other contaminants contained in paint imperfections. The flat level spray of fluid covers a broader range than that of conical spray nozzles and may evenly distribute turbulent air along the flat level broad range.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. An airflow apparatus comprising:
an intake housing comprising an air intake;
a motor within the intake housing for directing airflow through the intake;
a hollow extension having a first surface, a length and a volume therein protruding from the intake housing; and
a first slit in the first surface, wherein the motor directs the airflow through the intake, into the hollow extension and out the first slit.

2. The airflow apparatus of claim 1 further comprising:
a directional airflow element disposed over the first slit, wherein the directional airflow element comprises a first flange extending from the surface on a first side of the first slit and a second flange extending from the surface on a second side of the first slit.

3. The airflow apparatus of claim 1 further comprising:
a second slit in the first surface, wherein the motor directs the airflow through the intake, into the hollow extension, and out the second slit.

4. The airflow apparatus of claim 3 wherein the first and second slits are adjacently disposed on the first surface.

5. The airflow apparatus of claim 3 wherein the second slit comprises a directional airflow element disposed over the second slit, wherein the directional airflow element comprises a first flange extending form the surface on a first side of the second slit and a second flange extending from the surface on a second side of the first slit.

6. The airflow apparatus of claim 1 further comprising:
a first air diffuser disposed within the hollow extension, wherein the first air diffuser comprises at least one hole for the airflow to pass therethrough, said first air diffuser disposed between the intake housing and the first slit.

7. The airflow apparatus of claim 3 further comprising:
a first air diffuser disposed within the hollow extension, wherein the first air diffuser comprises at least one hole for the airflow to pass therethrough, said first air diffuser disposed between the intake housing and the first slit; and
a second air diffuser disposed within the hollow extension, wherein the second air diffuser comprises at least one hole for the airflow to pass therethrough, said second air diffuser disposed between the first slit and the second slit.

8. The airflow apparatus of claim 1 further comprising:
an end cap on a terminal end of the hollow extension.

9. The airflow apparatus of claim 1 further comprising:
a filter associated with the air intake for filtering air forming the airflow.

10. A paint spray booth comprising:
an enclosed space surrounded by walls, a ceiling, and a floor, wherein mounted on one wall is an airflow apparatus, said airflow apparatus comprising an intake housing comprising an air intake, a motor within the intake housing for directing airflow through the intake, a hollow extension having a first surface, a length and a volume therein protruding from the intake housing, and a first slit in the first surface, wherein the motor directs the airflow through the intake, into the hollow extension and out the first slit.

11. The paint spray booth of claim 10 further comprising:
a directional airflow element disposed over the first slit of the airflow apparatus, wherein the directional airflow element comprises a first flange extending from the surface on a first side of the first slit and a second flange extending from the surface on a second side of the first slit.

12. The paint spray booth of claim 10 further comprising:
a second slit in the first surface of the airflow apparatus, wherein the motor directs the airflow through the intake, into the hollow extension, and out the second slit.

13. The paint spray booth of claim 12 wherein the first and second slits of the airflow apparatus are adjacently disposed on the first surface.

14. The paint spray booth of claim 12 wherein the second slit of the airflow apparatus comprises a directional airflow element disposed over the second slit, wherein the directional airflow element comprises a first flange extending form the surface on a first side of the second slit and a second flange extending from the surface on a second side of the first slit.

15. The paint spray booth of claim 10 further comprising:
a first air diffuser disposed within the hollow extension of the airflow apparatus, wherein the first air diffuser comprises at least one hole for the airflow to pass therethrough, said first air diffuser disposed between the intake housing and the first slit.

16. The paint spray booth of claim 12 further comprising:
a first air diffuser disposed within the hollow extension of the airflow apparatus, wherein the first air diffuser comprises at least one hole for the airflow to pass therethrough, said first air diffuser disposed between the intake housing and the first slit; and
a second air diffuser disposed within the hollow extension of the airflow apparatus, wherein the second air diffuser comprises at least one hole for the airflow to pass therethrough, said second air diffuser disposed between the first slit and the second slit.

17. The paint spray booth of claim 10 wherein the first surface is angled downwardly toward the floor to direct the airflow toward the floor.

18. The paint spray booth of claim 10 further comprising:
a filter associated with the air intake for filtering air forming the airflow.

19. The paint spray booth of claim 10 further comprising:
a ventilation system for removing air from the enclosed space.

20. The paint spray booth of claim 10 further comprising:
an object disposed within the enclosed area, the airflow apparatus directing the airflow around the object for curing paint disposed on the object.
